(19) United States
(12) Patent Application Publication
(10) Pub. No.: US 2009/0285189 A1
(43) Pub. Date: Nov. 19, 2009

(54) Wlan Combo Access Point Device for Interface With WiMedia UWB Based Wireless USB and Software Layer Structure of Combo Access Point Device

(76) Inventors: You-Jin Kim, Daejeon (KR); Jae-Doo Huh, Daejeon (KR)

Correspondence Address: STAAS & HALSEY LLP, SUITE 700, 1201 NEW YORK AVENUE, N.W., WASHINGTON, DC, 20005, US

(21) Appl. No.: 12/086,054

(22) PCT Filed: Nov. 23, 2006
(86) PCT No.: PCT/KR2006/004948

§ 371 Date: Jun. 5, 2008

(30) Foreign Application Priority Data
Dec. 8, 2005 (KR) 10-2005-0120233

(51) Int. Cl. H04W 88/08; H04B 1/38

(52) U.S. Cl. 370/338; 375/222

(57) ABSTRACT

Provided is a combo access point (AP) device integrated with an WiMedia ultra wideband (UWB) based wireless universal serial bus (WUSB) and a wireless local area network (WLAN) AP. A combo AP device includes a wireless local area network (WLAN) AP block providing wire and wireless telecommunications interfaces, and a wireless universal serial bus (WUSB) block configured in one integral structure with the WLAN AP block and providing a ultra wideband (UWB) based wireless interface with WUSB devices using a WiMedia UWB interface mode. Configuring the combo AP device by matching the functions of the WLAN AP with the WiMedia UWB based WUSB interface can provide dual functions of the WUSB and the WLAN AP and allows personal computer users to easily access commonly shared WUSB devices.

### TECHNICAL FIELD

The present invention relates to an access point device in a wireless local area network (WLAN), and more particularly, to a WLAN combo access point device that can make an interface with a wireless universal serial bus (WUSB) block using a ultra wideband (UWB) provided by the WiMedia alliance group and a software layer structure of the same device.

### BACKGROUND ART

Generally, a WIAN access point device makes a connection between a WLAN and a wire network. Based on this function, the WLAN access point device transfers Ethernet packets from a WLAN system to a wire network system and transforms the Ethernet packets from the wire network system into wireless Ethernet packets.

A typical WUSB host interface function is a combined technology of a UWB based wireless technique and a wire USB technique based on the conveniently and commonly usable wire USB. The WUSB host interface function includes functions of the wire USB and a security function and is added with convenience provided from a wireless condition. A WUSB host makes a point-to-point direct connection with target devices, creating a star-shaped topology.

FIG. 1 illustrates an exemplary telecommunications connection configuration diagram of a conventional WUSB host and WUSB devices.

The WUSH devices 102, 103, 104, 105, 106 and 107 make a wireless interface with the WUSH host 101 in a star-shaped topology according to WiMedia with the WUSH schemes.The WUSB host 101 is called “host wire adapter (HWA)”, and the WUSB devices 102 to 107 are called “device wire adapters “DWAs”.

This single WUSB host 101 and the multiple WUSB devices 102 to 107 are referred to as “cluster”. Different from a wire USB system, this WUSB system does not have a hub in the connection structure between the WUSB host 101 and the WUSB devices 102 to 107. The WUSB host 101 can logically connect about 127 devices with each other, initiates a data transfer with the WUSB devices 102 to 107 of the cluster, provides a schedule, and allocates a time slot and a bandwidth to the individual WUSB devices 102 to 107. Several WUSB clusters can co-exist together within the same wireless cell since the clusters can be spatially superimposed with each other with the minimum interference.

The typical WUSB uses a WiMedia UWB signal as a wireless transmission medium. The UWB allows a high-speed transmission of 53.3 Mbps to 480 Mbps at a frequency band between 3.1 GHz and 10.6 GHz, consumes less power, disallows wiretapping, and gives good security and accurate location recognition. A target power of the typical WUSB is less than 300 mW and 100 mW at an initial stage and a final stage, respectively. Therefore, a power management technology that can awake upon a request while being in a sleep mode and stops the power dissipation when in an idle state is necessary in a WUSB telecommunications system.

When implementing the WUSB system for the device connection, one goal is to allow ease installation and operation. For this goal, standards for the WUSB system are set to support the following characteristics.

First, as for down-compatibility, the WUSB system has complete down-compatibility with about 1000 millions of wire USBs that have been used. Also, the WUSB system is compatible with current USB drivers and firmware and functions as a mediator that allows wireless telecommunications between wire USB devices and wire USB hosts.

Second, as for high performance, during an initiation period, the WUSB system allows wireless transmission of digital multimedia frames by providing a maximum transfer speed of 480 Mbps compatible with the wire USB 2.0 standard.

Third, as for simple and cost-effective implementation, the WUSB system can shorten a developmental period and follows wire USB connection models as many as possible to give cost-effectiveness and easy usability.

Fourth, as for an easy transfer, the WUSB system retains utility models and structures that are same as those used in the wire USB system so that the WUSB system can provide an easy transfer path.

Fifth, as for a host-to-device structure, the WUSB system makes a point-to-point connection between the hosts and the devices. The WUSB system employs a non-symmetrical host-based model in which complexity is limited to a host to provide convenient usability.

FIG. 2 illustrates a simplified access point configuration in a WLAN.

The conventional WLAN access point includes a radio frequency (RF) block 201, a modem 202, a wireless media access control (MAC) engine 212 and a wire and wireless processor 213. The RF block 201 interfaces wireless channels with each other. The modem 202 modulates or demodulates those signals that have been received wirelessly or are to be transmitted wirelessly. The wireless MAC engine 212 is an MAC device that controls access to media The wire and wireless processor 213 transmits those packets that are outputted from the wireless MAC engine 212 to a cable 214 and transmits wirelessly those packets that are inputted from the cable 214. In general, together the RF block 201 and the modem 202 are referred to as a physical layer.

The wireless MAC engine 212 includes a physical layer interface unit 203, a memory unit 204, a microprocessor unit 205, and a host bus interface unit 206. The physical layer interface unit 203 interfaces the physical layer with another target unit or device. The microprocessor unit 205 is configured with a logic that executes MAC and with a microprocessor logic including microprocessors. The memory unit 204 is necessary for the microprocessor unit 205 to execute programming codes. The host bus interface unit 206 provides an interface between the microprocessor unit 205 and a host system.

The wireless MAC engine 212 has the following functions. Usually, since multiple users of a WLAN system commonly share a single wireless channel, pieces of user information are often crashed on the wireless channel if the transmission between the users is not controlled appropriately. As a result, the information transmission may not be allowed, or performance of the wireless channel may be degraded.

A technique that controls authority of using transmission media commonly shared by multiple users is called MAC.

In the WLAN standardized specs set by the IEEE 802.11 work group, a MAC layer controls multiple terminals to effectively use a commonly shared channel with the minimum interference and the maximum performance. In more detail, the MAC layer controls the competition that often occurs when data are outputted from a common source (e.g., the commonly shared channel) and detects a defect in a transmission path.

An access method of the MAC set by the IEEE 802.11 work group includes a distributed coordination function (DCF), which is known as “carrier sense multiple access with collision avoidance (CSMA/CA)”. The DCF needs to be implemented in all stations. A station that wishes to transmit a frame senses media to check whether other stations are transmitting frames. If the media are not busy, a transmission operation starts.

A minimum period at which no station is allowed to use media is set between frames that are consecutively transmitted. According to the IEEE 802.11 standardized specs, this minimum period is called “inter-frame space (IFS)”. If the media is being used, the station is delayed until the current transmission is finished. After the delay, the station is delayed again for a random period. The latter delay is called a random back off defer delay. Prior to transmitting a data frame, short control frames such as request to send (RTS) and clear to send (CTS) frames can be exchanged to avoid collisions during the transmission.

A CSMA/CA protocol is designed to reduce a chance of collision at a point where the stations that access media are likely to have the transmission collision. Typically, the collision is more likely to occur when the media change from a busy state to a free state because, while the media are being used, all of the stations that are to transmit data are awaiting for the free state of the media Thus, the WLAN employs the random back off defer delay to avoid the collision.

A carrier sense (CS) function that senses whether other stations are using the media is implemented based on a physical mechanism and a virtual mechanism. The virtual carrier sense mechanism uses a kind of a reservation function that precedently informs the other stations of a time to use the media This reservation information can be transmitted by being included within the RTS and CTS frames that are exchanged prior to the actual data frame transmission.

More specifically, the RTS and CTS frames include a duration field on which a time to transmit the actual data frame and receive a response frame to the actual data frame transmission is recorded and transmit this reservation information. Those stations within a frequency range where an outgoing station that sends the RTS frame and an incoming station that sends the CTS frame can receive the RTS and CTS frames. Therefore, those stations except for the outgoing and incoming stations of the RTS and CTS frames do not use the media during a period of time designated by the duration field. Hence, the media can be reserved for a desired duration time. This operation is called the virtual carrier sense mechanism.

A data frame usually includes a duration field for the reservation information. A value of the duration field is a period of time to receive a response to the transmitted data frame. Since the RTS and CTS frames are generally shorter than the data frame, a potential collision can be sensed quickly through the exchange of the RTS and CTS frames and a transmission path can also be sensed quickly. However, if the data frame is shorter than the RTS and CTS frames, the exchange of the RTS and CTS frames may become an overhead. In this case, the exchange of the RTS and CTS frames does not occur. For a broadcast/multicast frame that has multiple destinations, the aforementioned RTS/CTS mechanism is not applied.

A distributed control method is used as a basic control method, and a polling based central control method is also used optionally. Particularly, a WLAN system that supports various high-speed multimedia services can have a high-speed process rate and is equipped with a power control function for effective use of power and long-term use of mobile terminals.

Pieces of software and hardware are generally required to implement the above-described functions of the wireless MAC engine 212. The microprocessor unit 205 illustrated in FIG. 2 provides the required configuration of the pieces of software and hardware. Some functions of the wireless MAC engine 212 that can be implemented with the software rely on the functions of the microprocessors.

The wire and wireless processor 213 changes the wireless MAC engine 212 into a wire network. The wire and wireless processor 213 includes another host bus interface unit 207, another microprocessor unit 209, another memory unit 208, a wire media interface unit 210, and a transceiver 211. The other host bus interface unit 207 makes an interface with the host bus interface unit 206 of the wireless MAC engine 212. The other microprocessor unit 209 changes a wireless packet from the wireless MAC engine 212 into a wire packet or operates other pieces of application software. The other memory unit 208 is necessary for operating programming codes of the other microprocessor unit 209. The wire media interface unit 210 interfaces the wire and wireless processor 213 with other devices such as routers through a cable 214. The cable 214 makes an interface with the transceiver 211 is connected to an Internet network.

FIG. 3 illustrates a configuration diagram of a network using the typical WUSB and WLAN.

Personal computers such as laptop computers and desktop computers 303, 307 and 315 make a corresponding interface with WLAN stations 306 and 317 and WUSB hosts 308 and 314. The WUSB hosts 308 and 314 are interfaced with WUSB devices 310, 311, 312, and 313 using WiMedia UWB wireless interfaces 309 and 316. The personal computers 307, 315 and 303 can send or receive information/data to or from the WUSB devices 310 to 313. Also, on the basis of a WLAN interface method set by the IEEE 802.11 work group, the personal computers 307, 315 and 303 perform data communications with a WLAN access point (AP) 301 through the WLAN stations 306 and 317. The WLAN AP 301 is connected to an external Internet network 302. As a result, another personal computer 303 connected to the Internet network 302 communicates with the personal computers 307 and 315 through the Internet network 302 and the WLAN AP 301 in sequential order.

FIG. 4 illustrates a software configuration diagram of a conventional WLAN AP system.

The conventional WLAN AP system connects a wireless physical layer 401 interface with a wire physical layer 408 interface. In a user application layer 406, a protocol for controlling packets operates. The user application layer 406 manages wireless terminals that are connected to a WLAN AP.

As for a data flow 409, when an interface is made between the corresponding wireless terminal and the wireless physical layer 401, a corresponding packet is transferred to a wireless MAC layer 402, and then to the user application layer 406 through a device driver layer 403, a kernel layer 404 and a kernel network layer 405 in sequential order. The packet is transferred from the user application layer 406 to a wire MAC layer 407 through the kernel network layer 405, the kernel layer 404 and the device driver layer 403 in sequential order based on a control operation. The packet is then transferred to the wire physical layer 408 and to a wire Internet network thereafter. A wire-to-wireless packet transfer operation is an inversed flow of the above-described data flow 409.

FIG. 5 illustrates a software configuration diagram of a conventional WUSB system.

The WUSB system includes a WiMedia UWB physical layer 501, a WiMedia UWB MAC layer 502, and a convergence layer 503 necessary for matching with an upper protocol.

The upper protocol of the convergence layer 503 may include a wireless USB protocol 504, an IP (WiNet) protocol 505, a wireless 1394 protocol 507, and other applications 506.

As one exemplary related ait, in the Korean patent application No. 10-2003-0014274 filed on Mar. 7, 2003, entitled “Wireless LAN System and Method of Using the Same”, the wireless LAN system includes at least one ISCM device and an AP point. The ISCM device collects channel information related to channels used in a peripheral wireless network and transfers the channel information to a target device. The AP includes a module that adjusts a currently set channel into a channel at another frequency band based on a comparison result between the received channel information and the currently set channel. This introduced configuration can prevent an incidence of frequency interference and cross with other wireless LAN systems located in a peripheral region.

Also, the Korean patent application No. 10-2003-0012889 filed on Feb. 28, 2003, entitled “Method for Time Merge of GPS to WLAN Access Point” teaches a method for merging a global positioning system (GPS) to a WLAN AP on the basis of a GPS time used as a clock reference of a CDMA system. According to this method, various applications interfaced with the AP have time consistency. For this time merge method, time information is extracted using GPS employed in the conventional CDMA system and then transferred to a PDSN that can be interfaced with the CDMA system and an IP network. Using this time information, the AP of a WLAN system can use an accurate GPS time at a station card interfaced with the AP. This method can also be applied to the IEEE1394, Bluetooth and a home automation system in addition to the station card.

Furthermore, in the Korean patent application No. 10-2002-0080313 filed on Dec. 16, 2002, entitled “System for Linking of Wireless and Cellular Network and Method thereof, its Program Storing Recording Medium”, a WLAN system is applied to a wireless interface network of a cellular network that makes an organic connection with a key network and a mobile or wireless terminal. The wireless interface network of the cellular network includes multiple interface devices and an interface control device. The multiple interface devices make an interface using the same interface within the wireless interface network and output data and a control signal by being wirelessly interfaced with the wireless terminal using the WLAN specs. The interface control device is connected with the multiple interface devices. Through this connection, the interface control device receives the data and control signal from the multiple interface devices and transfers the received data and control signal to the key network. The interface control device makes an interface as same as the key network and the wireless network. For the WLAN system, a wireless interface interval is operated according the IEEE 802.11 physical layer and the 802.11e MAC protocol improved in a quality of services. This operation allows support of mobile services and selective linking to the WLAN and the cellular network. As a result of the selective linking, a dual mode can be supported. Also, a control signal for setting a call can be transmitted in real time, and a desired level of service quality related to the user associated traffic can be obtained.

The above conventional methods mainly focus on the functions of the WLAN and those of the WLAN AP that are used to support the WLAN functions. Generally, the conventional WLAN AP does not have the WiMedia UWB based WUSB function, and the wireless USB function does not also have the WLAN AP finction.

The above-described conventional methods focus simply on the functions of transmitting and receiving data from WUSB devices connected to WUSB hosts. However, most personal computers can make a connection with an Internet network and have WLAN interfaces. Thus, during Internet-based telecommunications, for instance, when one personal computer attempts to make an interface with a WUSB host of another personal computer, a security related disadvantage such as attainment of user's authentication and a privacy related disadvantage may arise. Also, it may be inconvenient to use WUSB devices that are usually designed to be used commonly.

### DISCLOSURE OF INVENTION

### Technical Problem

One object of the present invention is to provide a telecommunications relay interface device and a method that can accommodate functions of a WUSB interface block and a WLAN AP, and to provide a software layer structure of the same device.

Another object of the present invention is to provide a telecommunications relay interface device and a method that can accommodate functions of a WUSB interface block and a WLAN AP and are configured such that personal computer users can easily access WUSB devices, and to provide a software layer structure of the same device.

A further object of the present invention is to provide a telecommunications relay interface device and a method that can provide integrated functions of an AP and a USB in a wireless condition by matching functions of a wireless AP with a WiMedia UWB based WUSB interface block, and to provide a software layer structure of the same device.

### Technical Solution

In order to achieve the above objects, in one embodiment, the present invention provides a combo access point (AP) device comprising: a wireless local area network (WLAN) AP block providing wire and wireless telecommunications interfaces; and a wireless universal serial bus (WUSB) block configured in one integral structure with the WLAN AP block and providing a ultra wideband (UWB) based wireless interface with WUSB devices using a WiMedia UWB interface mode.

In another embodiment, the present invention also provides a combo AP device comprising: a USB wireless interface block for a WiMedia UWB based telecommunications interface; a LAN wireless interface block for a physical layer interface between a wire LAN and a wireless LAN through a WLAN; and a wire interface block capable of interlocking with a wire network.

In still another embodiment, the present invention also provides a software layer structure of a combo AP device comprising a WUSB interface block and a WLAN AP, the software layer structure comprising: a lower layer comprising a WiMedia UWB physical layer, a WLAN physical layer and a wire physical layer; a MAC layer comprising a WiMedia UWB MAC layer disposed above the WiMedia UWB physical layer, a WLAN MAC layer disposed above the WLAN physical layer and a wire MAC layer disposed above the wire physical layer; a device driver layer disposed above the MAC layer; a kernel layer disposed above the device driver layer; a kernel network layer disposed above the kernel layer; and a user application layer disposed above the kernel network layer.

In further another embodiment, the present invention provides a method for a WUSB interface in a WLAN based combo AP device configured to make an interface with a WUSB block using a WiMedia USB, the method comprising: if a personal computer needs to use commonly shared WUSB devices through a WLAN, making an interface with a WLAN physical layer of a predetermined software layer structure; and making an interface with a WLAN MAC layer of the predetermined software layer structure; if a data is to be transmitted, transmitting the data to a WiMedia UWB MAC layer of the predetermined software layer structure from a device driver layer thereof; and if a piece of control information is to be transmitted, transmitting the piece of the control information to a kernel layer, a kernel network layer and a user application layer of the predetermined software layer. The method further comprises: if a personal computer needs to use commonly shared WUSB devices through a wire interface block, making an interface with a wire physical layer of a predetermined software layer structure; and making an interface with a wire MAC layer of the predetermined software layer structure; if a data is to be transmitted, transmitting the data to a WiMedia UWB MAC layer of the predetermined software layer structure from a device driver layer thereof; and if a piece of control information is to be transmitted, transmitting the piece of the control information to a kernel layer, a kernel network layer and a user application layer of the predetermined software layer.

### Advantageous Effects

According to various embodiments of the present invention, the combo AP device that is configured by matching the functions of the WLAN AP with the WiMedia UWB based WUSB interface block can provide dual functions provided from the WUSB block and the WLAN AP and allows personal computer users to easily access WUSB devices used for the sharing purpose.

Configuring the combo AP device with integrated functions of the WLAN AP and the WiMedia UWB based WUSB interface makes it possible to increase cost-effectiveness and convenience for users.

The combo AP device is configured to provide an easier information exchange between personal computers installed with the WUSB devices and the WLAN stations without using the typical convergence layer. Hence, the combo AP device mediates the data amount and speed, and as a result, those personal computers installed with the WLAN stations can commonly share various WUSB devices.

### BRIEF DESCRIPTION OF THE DRAWINGS

The above objects, other features and advantages of the present invention will become more apparent by describing the preferred embodiments thereof with reference to the accompanying drawings, in which:

FIG. 1 illustrates an exemplary telecommunications connection configuration diagram of a conventional WUSB host and WUSB devices;

FIG. 2 illustrates a configuration diagram of an access point in a WLAN system;

FIG. 3 illustrates a configuration diagram of a network using conventional WUSB and WLAN;

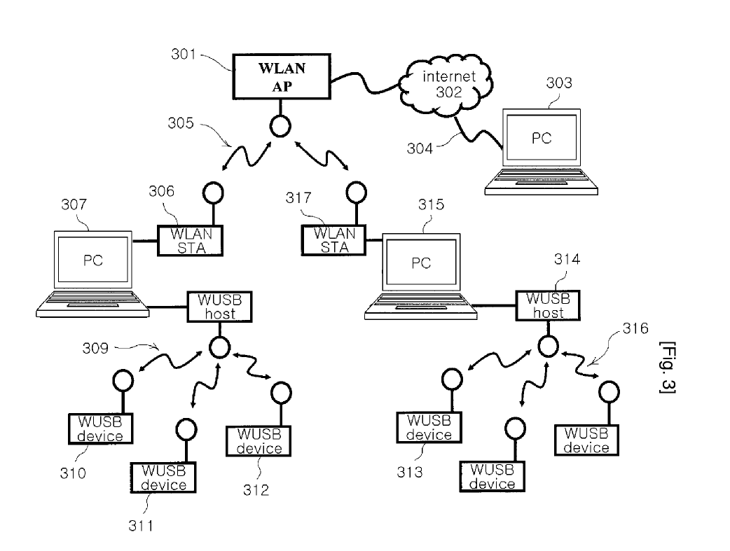

FIG. 4 illustrates a software configuration diagram of a conventional WLAN AP system;

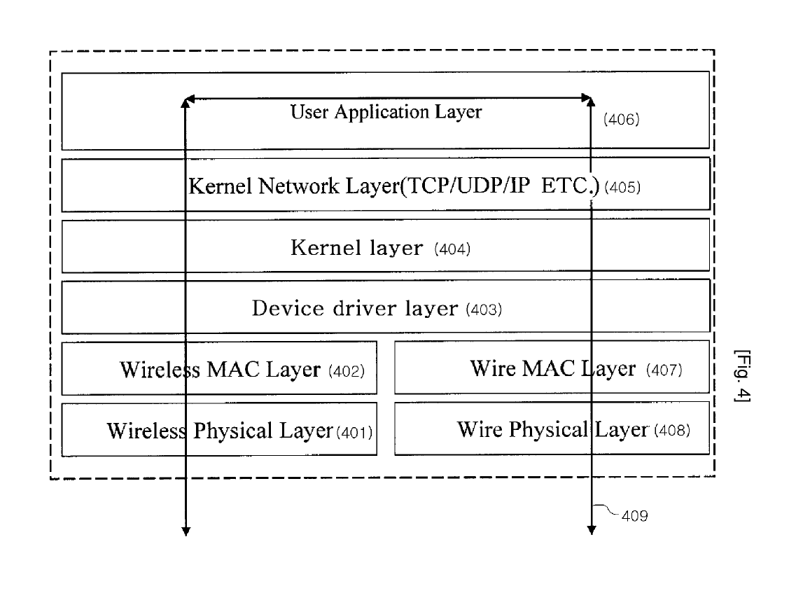

FIG. 5 illustrates a software configuration diagram of a conventional WUSB system;

FIG. 6 illustrates a configuration diagram of a network using a combo AP device including a WUSB block and a WLAN block according to an embodiment of the present invention;

FIG. 7 illustrates a detailed configuration diagram of the combo AP device illustrated in FIG. 6 according to an embodiment of the present invention; and

FIG. 8 illustrates a software configuration diagram of the combo AP device using the WUSB block and the WLAN block according to an embodiment of the present invention.

### BEST MODE FOR CARRYING OUT THE INVENTION

Hereinafter, preferred embodiments of the present invention will be described in detail with reference to the attached drawings. It should be noted that like reference numeral denote like elements even in different drawings. Detailed description of the known function or configuration will be omitted when determined that the description unnecessarily makes the scope and sprit of the present invention ambiguous.

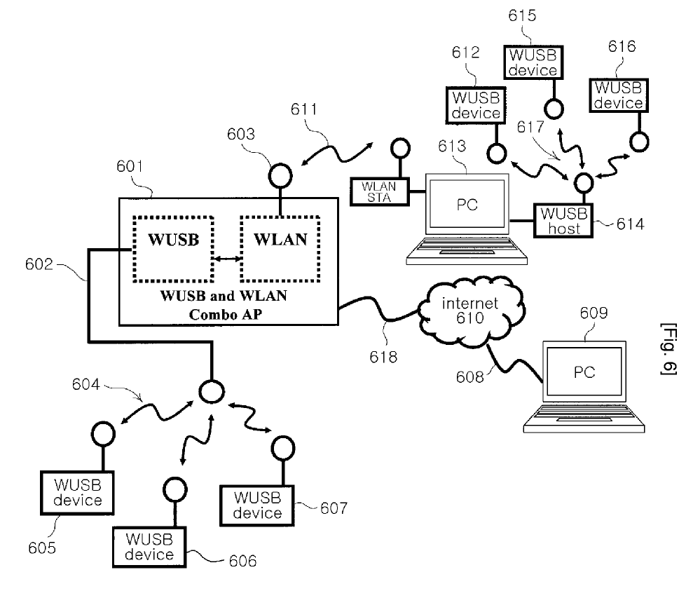

FIG. 6 illustrates a configuration diagram of a network using a combo AP device including a WUSB block and a WLAN block according to an embodiment of the present invention.

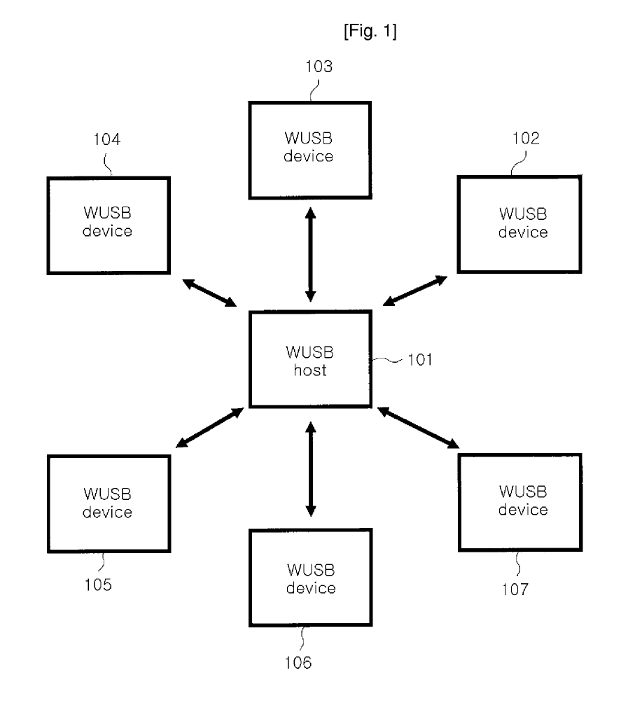

The network configuration using the combo AP device is not limited to FIG. 1. This network configuration can be applied to other configurations with using a combo AP or gateway that includes at least two different WUSB and WLAN interface blocks.

As illustrated, the WUSB and WLAN-based combo AP device 601 has three wireless interface blocks.

The three wireless interface blocks are a wireless interface block 602 for a WiMedia UWB, a WLAN interface block 603 for an IEEE 802.11 related physical layer, and a wire interface block 618 that can interlock with a wire network.

A personal computer 609 makes a connection to an Internet network 610 through an Internet interface block 608 and to the combo AP device 601 through the wire interface block 618 of the combo AP device 601. WUSB devices 605, 606 and 607 that can be usable commonly make an interface with the combo AP device 601 through the wireless interface block 602 according to an UWB based wireless interface mode 604.

The combo AP device 601 performs a temporary data storage function (i.e., a buffering function) to reduce data loss due to a difference between an Internet based data speed and an USB based data speed. Another personal computer 613 makes an interface with the WLAN interface block 603 of the combo AP device 601 using an interface block of a WLAN station WLAN STA to communicate with the personal computer 609. This interface between the other personal computer 613 and the WLAN interface block 603 is based on a wireless interface mode 611 defined by the IEEE 802.11 related physical layer. Hence, the other personal computer 613 can transfer data through the Internet network 610 by being interfaced with the combo AP device 601.

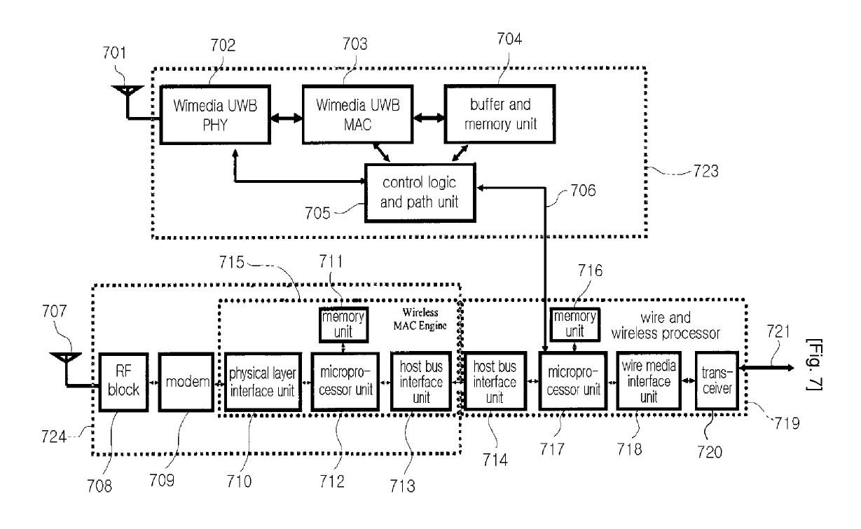

FIG. 7 illustrates a detailed configuration diagram of the combo AP device 601 illustrated in FIG. 6 according to an embodiment of the present invention.

The combo AP device 601 (refer to FIG. 6) includes a WLAN block 724 and a WUSB block 723.

In more detail, the WUSB block 723 includes an antenna 701, a WiMedia UWB physical layer 702, a WiMedia UWB MAC unit 703, a buffer and memory unit 704, and a control logic and path unit 705. The WiMedia UWB MAC unit 703 manages MAC of devices that make an interface with the WiMedia UWB physical layer 702. The buffer and memory unit 704 buffers data transmission and receiving activities. The control logic and path 705 controls the WiMedia UWB physical layer 702, the WiMedia UWB MAC unit 703 and the buffer and memory unit 704.

The WLAN block 724 has substantially the same configuration known in the art. However, the WLAN block 724 is connected to the WUSB block 723 through a wire and wireless processor 719. The WLAN block 724 is connected to the Internet through a wire interface 721. A WLAN interface antenna 707 receives and transmits data. A RF unit 708 and modem 709 are configured for the data transmission and receiving activities. A wireless MAC engine 715 performs MAC of other stations interfaced with the WLAN block 724 and makes a connection with a microprocessor unit 717 through host bus interface units 713 and 714. The microprocessor unit 717 serving as a central processor of the combo AP device 601 controls the WUSB block 723.

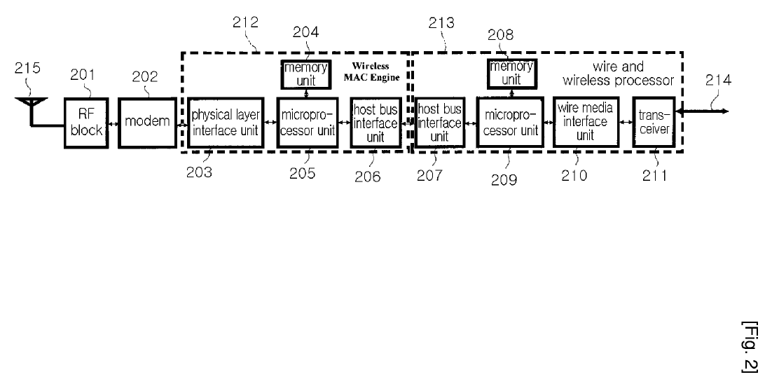

Those non-described units and elements of the WLAN block 724 are substantially the same as those units and elements described in FIG. 2 and perform substantially the same functions as described in FIG. 2. Thus, detailed description thereof will be omitted.

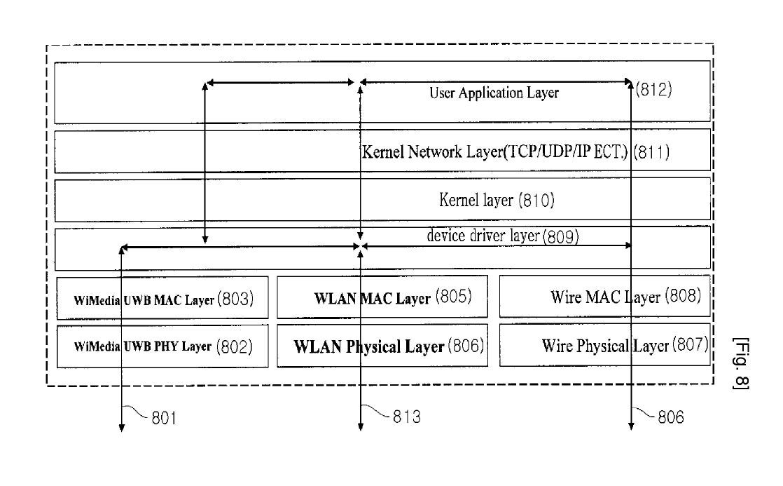

FIG. 8 illustrates a software configuration diagram of the combo AP device 601 using the WUSB and WLAN blocks according to an embodiment of the present invention.

The microprocessor unit 717 illustrated in FIG. 7 performs operations related to a device driver layer 809, a kernel layer 810, which is an operating system, a network layer 811 interlocking with the kernel layer 810, and user application layer 812 using the above listed layers.

If the other personal computer 613 illustrated in FIG. 6 are to use the commonly shared WUSB devices 605, 606 and 607 illustrated in FIG. 6 through the WLAN block, the other personal computer 613 makes an interface with a WLAN interface block 813. For data that have passed through a WLAN MAC layer 805, the data are transmitted from the device driver layer 809 to a WiMedia UWB MAC layer 803. Control information is transmitted to those upper layers including the kernel layer 810, the network layer 811 (more specifically, the kernel network layer 811), and the user application layer 812 in sequential order.

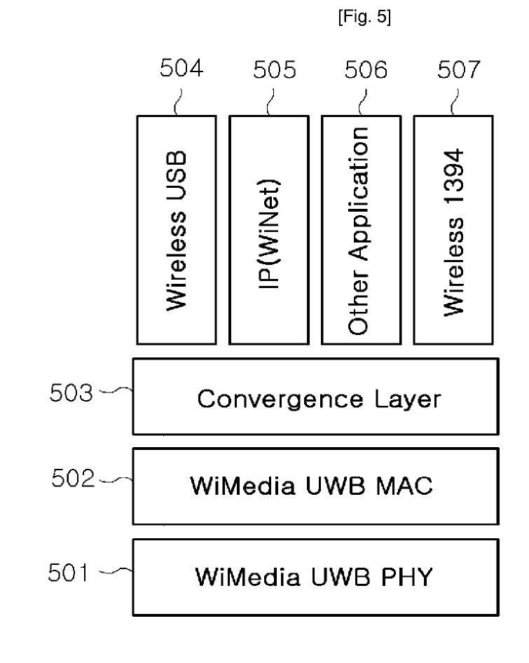

When data are transmitted through a wire interface block 806, the data are transmitted through the device driver layer 809, and the control information is transmitted to the upper layers. The data transmission takes place directly through the device driver layer 809 without using the conventional convergence layer 503 illustrated in FIG. 5. Thus, the data transmission can be carried out effectively.

Although the preferred embodiments of the present invention have been disclosed for illustrative purpose, those skilled in the art will appreciate that various modifications, additions and substitutions can be made without departing from the scope and spirit of the invention as defined in the accompanying claims.

1. A combo access point (AP) device comprising:
a wireless local area network (WLAN) AP block providing wire and wireless telecommunications interfaces; and
a wireless universal serial bus (WUSB) block configured in one integral structure with the WLAN AP block and providing a ultra wideband (UWB) based wireless interface with WUSB devices using a WiMedia UWB interface mode.

2. The combo AP device of claim 1, wherein the WLAN AP block comprises:
a radio frequency (RF) unit converting a signal to transmit and receive a corresponding data;
a modem that modulates and demodulates the corresponding data to a predetermined form;
a wireless media access control (MAC) engine performing MAC of stations interfaced with a WLAN block; and
a wire and wireless processor connected individually to the wireless MAC engine and the WUSB block and converting a signal to perform wire and wireless telecommunications for the corresponding data.

3. The combo AP device of claim 2, wherein the wire and wireless processor controls an operation of the WUSB block.

4. The combo AP device of claim 3, wherein the WUSB block comprises:
an antenna communicating with the WUSB devices using the WiNedia UWB wireless interface mode;
a WiMedia UWB physical layer converting a signal to transmit and receive a corresponding data received through the antenna;
a WiMedia UWB MAC unit performing MAC of the WUSB devices interfaced with the WiMedia UWB physical layer; and
a control logic and path unit controlling operations of the WiMedia UWB physical layer and the WiMedia UWB MAC unit according to the control by the wire and wireless processor.

5. The combo AP device of claim 4, wherein the WUSB block further comprises a buffer and memory unit buffering transmission and receiving of the corresponding data.

6. A combo AP device comprising:
a USB wireless interface block for a WiMedia UWB based telecommunications interface;
a LAN wireless interface block for a physical layer interface between a wire LAN and a wireless LAN through a WLAN; and
a wire interface block capable of interlocking with a wire network.

7. The combo AP device of claim 6, wherein the wire interface block allows personal computers to make an interface with an Internet network using an Internet interface mode and to make a wire interface with the combo AP device.

8. The combo AP device of claim 7, wherein the USB wireless interface block allows WUSB devices that are commonly usable to make an interface with the combo AP device based on an UWB based wireless interface mode.

9. The combo AP device of claim 8, further comprising a buffer and memory unit buffering functions of storing data temporarily and outputting the data to reduce data loss caused by a difference between an Internet based data speed and a WUSB based data speed.

10. The combo AP device of claim 9, wherein the LAN wireless interface block allows a personal computer to make an interface with the personal computer interfaced with the Internet network using a WLAN station based on a wireless interface mode of a physical layer mode provided by the IEEE 802.11 work group.

11. The combo AP device of claim 6, wherein the LAN wireless interface block comprises:
a RF unit converting a signal to transmit and receive a corresponding data;
a modem that modulates and demodulates the corresponding data to a predetermined form;
a wireless MAC engine performing MAC of other stations interfaced with a WLAN block; and
a wire and wireless processor connected individually to the wireless MAC engine and a WUSB block and converting a signal to perform wire and wireless telecommunications for the corresponding data.

12. The combo AP device of claim 11, wherein the wire and wireless processor controls an operation of the WUSB block.

13. The combo AP device of claim 12, wherein the USB wireless interface block comprises:
an antenna communicating with the WUSB devices using the UWB wireless interface mode;
a WiMedia UWB physical layer converting a signal to transmit and receive a corresponding data received through the antenna;
a WiMedia UWB MAC unit performing MAC of the WUSB devices interfaced with the WiMedia UWB physical layer; and
a control logic and path unit controlling operations of the WiMedia UWB physical layer and the WiMedia UWB MAC unit according to the control by the wire and wireless processor.

14. A software layer structure of a combo AP device comprising a WUSB interface block and a WLAN AP, the software layer structure comprising:
a lower layer comprising a WiMedia UWB physical layer, a WLAN physical layer and a wire physical layer;
a MAC layer comprising a WiMedia UWB MAC layer disposed above the WiMedia UWB physical layer, a WLAN MAC layer disposed above the WLAN physical layer and a wire MAC layer disposed above the wire physical layer;
a device driver layer disposed above the MAC layer;
a kernel layer disposed above the device driver layer;
a kernel network layer disposed above the kernel layer; and
a user application layer disposed above the kernel network layer.

15. A method for a WUSB interface in a WLAN based combo AP device configured to make an interface with a WUSB block using a WiMedia USB, the method comprising:
if a personal computer needs to use commonly shared WUSB devices through a WLAN,
making an interface with a WLAN physical layer of a predetermined software layer structure; and
making an interface with a WLAN MAC layer of the predetermined software layer structure;
if a data is to be transmitted,
transmitting the data to a WiMedia UWB MAC layer of the predetermined software layer structure from a device driver layer thereof; and
if a piece of control information is to be transmitted,
transmitting the piece of the control informnation to a kernel layer, a kernel network layer and a user application layer of the predetermined software layer.

16. The method of claim 15, further comprising:
if a personal computer needs to use commonly shared WUSB devices through a wire interface block,
making an interface with a wire physical layer of a predetermined software layer structure; and
making an interface with a wire MAC layer of the predetermined software layer structure;
if a data is to be transmitted,
transmitting the data to a WiMedia UWB MAC layer of the predetermined software layer structure from a device driver layer thereof; and
if a piece of control information is to be transmitted,
transmitting the piece of the control information to a kernel layer, a kernel network layer and a user application layer of the predetermined software layer.
